(19) United States
(12) Patent Application Publication
(10) Pub. No.: US 2023/0410014 A1
(43) Pub. Date: Dec. 21, 2023

(54) TOUR PLAN PROPOSAL METHOD AND TOUR PLAN PROPOSAL DEVICE

(71) Applicant: Toyota Jidosha Kabushiki Kaisha, Toyota-shi Aichi-ken (JP)

(72) Inventors: Miki Nomoto, Nagoya-shi Aichi-ken (JP); Yuka Nishiyama, Toyota-shi Aichi-ken (JP); Kenichi Okumura, Gotemba-shi Shizuoka-ken (JP); Ryota Tomizawa, Mishima-shi Shizuoka-ken (JP); Tatsuya Sugano, Sunto-gun Shizuoka-ken (JP); Yushi Seki, Ashigarakami-gun Kanagawa-ken (JP); Tokuhiro Masui, Nagoya-shi Aichi-ken (JP)

(73) Assignee: Toyota Jidosha Kabushiki Kaisha, Toyota-shi Aichi-ken (JP)

(21) Appl. No.: 18/135,269

(22) Filed: Apr. 17, 2023

(30) Foreign Application Priority Data
Jun. 21, 2022 (JP) 2022-099613

(51) Int. Cl. G06Q 10/0637; G06Q 50/14

(52) U.S. Cl. CPC G06Q 10/0637; G06Q 50/14

(57) ABSTRACT

Tour schedule information including information on locations of at least three sightseeing spots, information on stay times at these sightseeing spots, and information on a tour time frame to tour these sightseeing spots is acquired. A tour area including these sightseeing spots is set based on the information on the locations. The degrees of congestion in these sightseeing spots and in the tour area are predicted. Whether a candidate for a tour plan can be generated is determined based on the information on the stay times, the information on the tour time frame, and the degree of congestion in these sightseeing spots and in the tour area. When it is determined that the candidate for the tour plan cannot be generated, a candidate for an alternative tour plan, in which a part of these sightseeing spots is changed to a different sightseeing spot outside the tour area, is generated.

### CROSS-REFERENCE TO RELATED APPLICATION

This application claims priority to Japanese Patent Application No. 2022-099613 filed on Jun. 21, 2022, incorporated herein by reference in its entirety.

### BACKGROUND

### 1. Technical Field

The present disclosure relates to a method and a device for proposing a tour plan to tour at least three sightseeing spots by a vehicle to a user.

### 2. Description of Related Art

Japanese Unexamined Patent Application Publication No. 9-204475 (JP 9-204475 A) discloses a device for generating a travel plan for a user. When plan information, such as the destination (scenic spots, rest facilities, accommodation facilities, etc.) of a travel, the departure date and time of the travel, the point of departure, and the point of return, is entered, this conventional device searches for the basic stay time corresponding to the destination. The basic stay time is set in advance as the optimal time to use the destination. The conventional device makes a schedule and creates a travel plan by combining this basic stay time with the travel time required for traveling on the route from the point of departure to the destination and the route from the destination to the point of return.

### SUMMARY

The conventional device described above incorporates into its design the information on the supplementary items of a travel plan. These supplementary items include the information on the past traffic congestion trends and the information on traffic restrictions. Therefore, it is expected that this supplementary information makes it possible to increase the accuracy of the travel time required to travel to, and to stay at, the destination using a vehicle. However, these supplementary items do not include the degree of congestion in the destination. For this reason, a travel plan created by the conventional device described above tends to increase a possibility that, when the degree of congestion is high at the destination on the day of travel, the actual stay time becomes longer than the basic stay time.

In particular, when touring a plurality of sightseeing spots using a vehicle on a scheduled travel date and if the actual stay time at a particular sightseeing spot becomes long, it may be necessary to adjust the schedule, for example, by shortening the stay time at the sightseeing spot to be visited next. Therefore, when touring the sightseeing spots, it is desirable to create a travel plan (i.e., a tour plan) that takes into account the degree of congestion at each of the sightseeing spots.

It is an object of the present disclosure to provide a technique that can propose an appropriate travel plan to a user who wishes to tour the sightseeing spots on a scheduled travel date using a vehicle.

A first aspect of the present disclosure relates to a method for proposing a sightseeing spot tour plan to a user. The method has the following features. The method includes a step for acquiring tour schedule information of the user, a step for setting a tour area, a step for predicting degrees of congestion, a step for determining whether a candidate for a tour plan can be generated, and a step for generating a candidate for an alternative tour plan. In the step for acquiring tour schedule information of the user, the tour schedule information including information on locations of at least three sightseeing spots, information on stay times at the at least three sightseeing spots, and information on a tour time frame to tour the at least three sightseeing spots is acquired. In the step for setting a tour area, the tour area including the at least three sightseeing spots is set based on the information on the locations. In the step for predicting degrees of congestion, the degrees of congestion in the at least three sightseeing spots and the degree of congestion in the tour area are predicted. In the step for determining whether a candidate for a tour plan can be generated, it is determined whether a candidate for a tour plan to tour the at least three sightseeing spots by traveling using a vehicle can be generated based on the information on the stay times, the information on the tour time frame, the degrees of congestion in the at least three sightseeing spots, and the degree of congestion in the tour area. In the step for generating a candidate for an alternative tour plan, an alternative tour plan is generated when it is determined that the candidate for the tour plan cannot be generated. The alternative tour plan is a plan in which a part of the at least three sightseeing spots is changed to a different sightseeing spot located outside the tour area.

A second aspect of the present disclosure relates to a method for proposing a sightseeing spot tour plan to a user. The method has the following features. The method includes a step for acquiring tour schedule information of the user, a step for setting a tour area, a step for predicting degrees of congestion, a step for determining whether a candidate for a tour plan according to a visit order can be generated, and a step for generating a candidate for an alternative tour plan. In the step for acquiring tour schedule information of the user, the tour schedule information including information on locations of at least three sightseeing spots, information on stay times at the at least three sightseeing spots, information on a tour time frame to tour the at least three sightseeing spots, and the visit order to visit the at least three sightseeing spots is acquired. In the step for setting a tour area, the tour area including the at least three sightseeing spots is set based on the information on the locations. In the step for predicting degrees of congestion, the degrees of congestion in the at least three sightseeing spots and the degree of congestion in the tour area are predicted. In the step for determining whether a candidate for a tour plan according to a visit order can be generated, it is determined whether a candidate for a tour plan to visit the at least three sightseeing spots according to the visit order by traveling using a vehicle can be generated based on the information on the stay times, the information on the tour time frame, the degrees of congestion in the at least three sightseeing spots, and the degree of congestion in the tour area. In the step for generating a candidate for an alternative tour plan, an alternative plan is generated when it is determined that the candidate for the tour plan cannot be generated. The alternative tour plan is a plan in which the visit order to visit the at least three sightseeing sports is changed.

A third aspect of the present disclosure relates to a device for proposing a sightseeing spot tour plan to a user. The device has the following features. The device includes a processor configured to perform processing for acquiring tour schedule information of the user, processing for setting a tour area, processing for predicting degrees of congestion, processing for determining whether a candidate for a tour plan can be generated, and processing for generating a candidate for an alternative tour plan. In the processing for acquiring tour schedule information of the user, the tour schedule information including information on locations of at least three sightseeing spots, information on stay times at the at least three sightseeing spots, and information on a tour time frame to tour the at least three sightseeing spots is acquired. In the processing for setting a tour area, the tour area including the at least three sightseeing spots is set based on the information on the locations. In the processing for predicting degrees of congestion, the degrees of congestion in the at least three sightseeing spots and the degree of congestion in the tour area are predicted. In the processing for determining whether a candidate for a tour plan can be generated, it is determined whether a candidate for a tour plan to tour the at least three sightseeing spots by traveling using a vehicle can be generated based on the information on the stay times, the information on the tour time frame, the degrees of congestion in the at least three sightseeing spots, and the degree of congestion in the tour area. In the processing for generating a candidate for an alternative tour plan, an alternative tour plan is generated when it is determined that the candidate for the tour plan cannot be generated. The alternative tour plan is a plan in which a part of the at least three sightseeing spots is changed to a different sightseeing spot located outside the tour area.

A fourth aspect of the present disclosure relates to a device for proposing a sightseeing spot tour plan to a user. The device has the following features. The device includes a processor configured to perform processing for acquiring tour schedule information of the user, processing for setting a tour area, processing for predicting degrees of congestion, processing for determining whether a candidate for a tour plan according to a visit order can be generated, and processing for generating a candidate for an alternative tour plan. In the processing for acquiring tour schedule information of the user, the tour schedule information including information on locations of at least three sightseeing spots, information on stay times at the at least three sightseeing spots, information on a tour time frame to tour the at least three sightseeing spots, and a visit order to visit the at least three sightseeing spots is acquired. In the processing for setting a tour area, the tour area including the at least three sightseeing spots is set based on the information on the locations. In the processing for predicting degrees of congestion, the degrees of congestion in the at least three sightseeing spots and the degree of congestion in the tour area are predicted. In the processing for determining whether a candidate for a tour plan according to the visit order can be generated, it is determined whether a candidate for a tour plan to visit the at least three sightseeing spots according to the visit order by traveling using a vehicle can be generated based on the information on the stay times, the information on the tour time frame, the degrees of congestion in the at least three sightseeing spots, and the degree of congestion in the tour area. In the processing for generating a candidate for an alternative tour plan, an alternative tour plan is generated when it is determined that the candidate for the tour plan cannot be generated. The alternative tour plan is a plan in which the visit order to visit the at least three sightseeing sports is changed.

According to the first or third aspect, when a tour plan to tour at least three sightseeing spots is proposed, a candidate for the tour plan can be generated considering not only the degree of congestion in each of the sightseeing spots but also the degree of congestion in the tour area in which the sightseeing spots are included. In addition, when a candidate for a tour plan cannot be generated, a candidate for an alternative tour plan, in which a part of the sightseeing spots is changed to another sightseeing spot located outside the tour area before the change, can be generated. Therefore, a candidate for a tour plan or for an alternative tour plan can be proposed to the user who desires a tour plan.

According to the second or fourth aspect, when a visit order to visit sightseeing spots is included in the tour schedule information, a candidate for a tour plan can be generated considering not only the degree of congestion in each of the sightseeing spots but also the degree of congestion in the tour area in which these sightseeing spots are included. When a candidate for the tour plan cannot be generated, a candidate for an alternative tour plan in which the visit order is changed can be generated. Therefore, the second or fourth aspect gives the same effect as the first or third aspect.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the outline of an embodiment;

FIG. 2 is a diagram showing the outline of a method for generating a candidate for a tour plan;

FIG. 3 is a diagram showing the outline of a method for generating a candidate for a tour plan;

FIG. 4 is a diagram showing the outline of a method for generating a candidate for an alternative tour plan;

FIG. 5 is a diagram showing the outline of another method for generating a candidate for a tour plan;

FIG. 6 is a diagram showing the outline of another method for generating a candidate for a tour plan;

FIG. 7 is a diagram showing the outline of another method for generating a candidate for an alternative tour plan;

FIG. 8 is a diagram showing a configuration example of a proposal device according to the embodiment;

FIG. 9 is a diagram showing a generation example of a candidate for a tour plan;

FIG. 10 is a diagram showing a generation example of a candidate for a tour plan; and

FIG. 11 is a flowchart showing the flow of processing performed by an information processing device (processor) and particularly related to the embodiment.

### DETAILED DESCRIPTION OF EMBODIMENTS

A tour plan proposal method and a tour plan proposal device according to an embodiment of the present disclosure will be described below with reference to the drawings. The proposal method according to the embodiment is implemented by computer processing performed by a server that is the proposal device according to the embodiment. In the figures, the same reference numerals will be given to the same or similar part and the description thereof is simplified or omitted.

### 1. Outline

### 1-1. Sightseeing Service

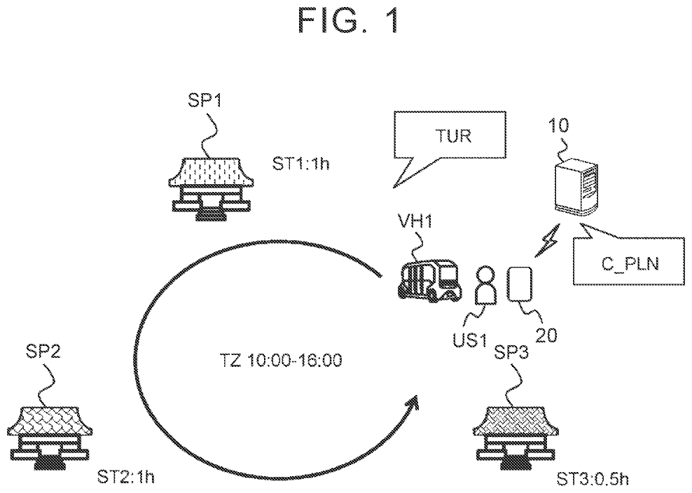

FIG. 1 is a diagram showing the outline of the embodiment. The proposal method according to the embodiment is performed as a part of the sightseeing service. The sightseeing service includes, for example, a service to rent a vehicle as method of traveling in a sightseeing area and a service to propose a plan to visit at least one sightseeing spot in the sightseeing area using this vehicle. Examples of sightseeing spots include scenic spots and tourist facilities scattered throughout the sightseeing area. Sightseeing spots include not only spots directly related to sightseeing but also spots indirectly related to sightseeing (e.g., rest spots such as restaurants, purchasing spots such as souvenir stores).

In the embodiment, focus is on the sightseeing service that proposes a plan to tour at least three sightseeing spots in a sightseeing area. FIG. 1 shows a user US1 who uses the sightseeing service. The user US1 is planning to tour at least three sightseeing spots in a certain sightseeing area using a vehicle VH1 owned or rented by the user. Although not particularly limited, the configuration of the vehicle VH1 in the present disclosure may have a configuration for autonomous driving. In the example shown in FIG. 1, the user US1 is planning to tour three sightseeing spots SP1 to SP3 in a certain time frame TZ (for example, 10:00 to 16:00) on the tour day, and the user US1 wants the service provider to propose a plan to tour these sightseeing spots.

The user US1 who wants the service provider to propose a plan to tour the spots SP1 to SP3 sends tour schedule information TUR to a server 10, for example, by operating a user terminal 20. In the example shown in FIG. 1, the tour schedule information TUR includes the information on the sightseeing spots SP1 to SP3, the information on stay times ST1 to ST3 at these sightseeing spots, and the information on a date (tour date) and time frame TZ (hereinafter also referred to as “tour time frame TZ_TUR”) in which the user will tour these sightseeing spots.

The information on the sightseeing spots SP1 to SP3 is not particularly limited as long as the information allows the server 10 to identify these sightseeing spots. This information may be specified by names, abbreviations, common names, etc., or may be specified by positions on a map. The information on the stay times ST1 to ST3 may or may not be specified by the user US1. In the latter case, the average stay times of tourists at the sightseeing spots SP1 to SP3 are set as the stay times ST1 to ST3, respectively. The tour time frame TZ_TUR for touring the sightseeing spots SP1 to SP3 is, for example, a time frame during which the user US1 stays in the sightseeing area. The tour time frame TZ_TUR may or may not be specified by the user US1. In the latter case, the tour time frame TZ_TUR is specified, for example, based on the alternative information (for example, the information the on a time slot such as A.M. and P.M., or the information on the rental time of the vehicle VH1).

### 1-2. Features of Embodiment

### 1-2-1. Generation of Candidate for Tour Plan

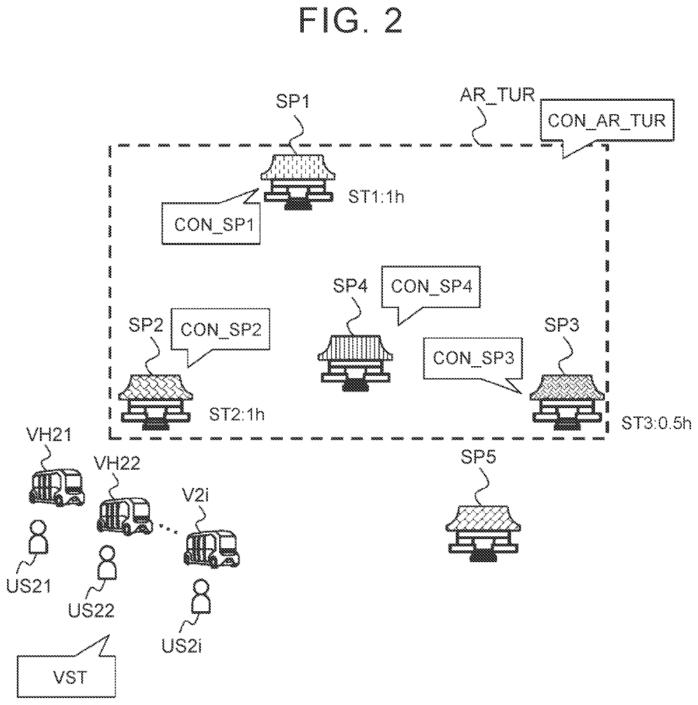

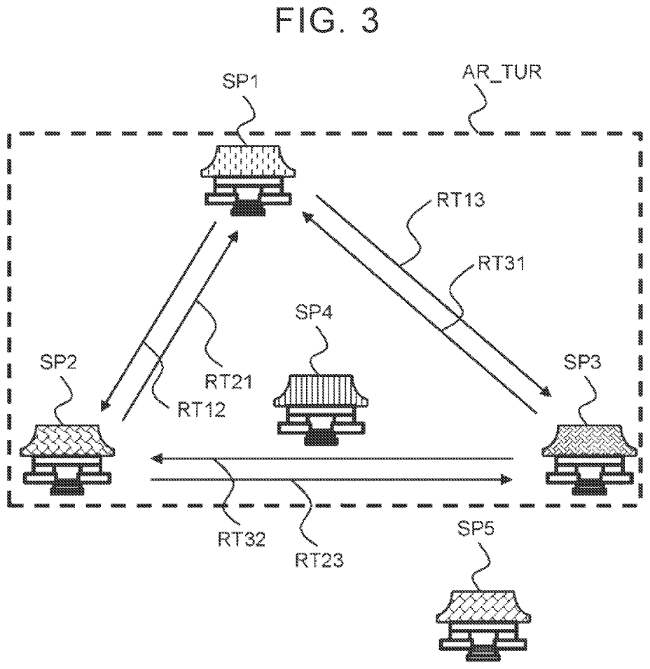

In the embodiment, a candidate C_PLN for a tour plan PLN for touring the sightseeing spots SP1 to SP3 is generated based on the tour schedule information TUR. FIG. 2 and FIG. 3 are diagrams showing the outline of a method for generating a candidate C_PLN. To generate a candidate C_PLN, a tour area AR_TUR is set first. As shown in FIG. 2, the tour area AR_TUR is set so that all of the sightseeing spots SP1 to SP3 are located inside the area. The tour area AR_TUR is set, for example, based on the location information on the sightseeing spots SP1 to SP3.

When the tour area AR_TUR is set, the other sightseeing spots that are located inside the tour area AR_TUR and are other than the sightseeing spots SP1 to SP3 are identified. The other sightseeing spots are identified based on the location information on the boundary of the tour area AR_TUR and the information on each of the locations of the other sightseeing spots. FIG. 2 shows the sightseeing spots SP4 and SP5. The sightseeing spot SP4 is an example of the other sightseeing spots located inside the tour area AR_TUR. The sightseeing spot SP5 is an example of the other sightseeing spots located outside the tour area AR_TUR. The sightseeing spot corresponding to the other sightseeing spots when the tour area AR_TUR is set is the sightseeing spot SP4.

When the sightseeing spots located inside the tour area AR_TUR (that is, the sightseeing spots SP1 to SP4) are identified, the degrees of congestion CON_SP1 to CON_SP4 of these sightseeing spots are predicted. The degrees of congestion CON_SP1 to CON_SP4 are calculated, for example, for each of a plurality of preset time slots. The time slots are set by dividing the tour time frame TZ_TUR, in which the sightseeing spots SP1 to SP3 are to be toured, into time ranges of tens of minutes to several hours (for example, minutes to 2 hours). All of these time slots may have the same time width, or some or all of the time slots may have different time widths.

The degrees of congestion CON_SP1 to CON_SP4 are calculated based on the visit schedule information VST that includes the information on a visit to at least one of the sightseeing spots SP1 to SP4 by the user US2i (i≤1). The user US2i is, for example, another user who uses the same sightseeing service as that used by the user US1. The user US2i has a schedule to visit at least one of the sightseeing spots SP1 to SP4 on the tour date of the user US1. The traveling methods of the user US2i is, for example, either a vehicle VHi owned or rented by the user or another type of vehicle (for example, a taxi).

The visit schedule information VST includes the information similar to that included in the tour schedule information TUR of the user US1. That is, the visit schedule information VST includes the information on at least one of the sightseeing spots SP1 to SP4 that the user US2i is to visit and the information on the visit time frame in which the user US2i is to visit the sightseeing spot.

Note that the visit schedule information VST used for calculating the degrees of congestion CON_SP1 to CON_SP4 is limited to that already generated when the candidate C_PLN is generated. That is, the visit schedule information VST generated in response to a request from the user US2i after the generation of the candidate C_PLN and the visit schedule information VST partially corrected in response to a request from the user US2i after the generation of the candidate C_PLN are neither used for the calculation of the degrees of congestion CON_SP1 to CON_SP4 nor taken into consideration for the generation of the candidate C_PLN.

In the embodiment, in addition to the degrees of congestion CON_SP1 to CON_SP4, the degree of congestion CON_AR_TUR of the tour area AR_TUR is also predicted. The degree of congestion CON_AR_TUR is calculated for each of the preset time slots in the same manner as the degrees of congestion CON_SP1 to CON_SP4. The degree of congestion CON_AR_TUR is calculated also based on the visit schedule information VST in the same manner as the degrees of congestionCON_SP1 to CON_SP4.

After the degrees of congestion CON_SP1 to CON_SP4 and the degree of congestion CON_AR_TUR are predicted, it is determined, based on these degrees of congestion, whether all the conditions are met for setting the time frame for visiting each of the sightseeing spots SP1 to SP3 (hereinafter referred to as “visit time frame TZ_SP1”, “visit time frame TZ_SP2”, and visit time frame TZ_SP3″, respectively). This determination is made, for example, based on whether all of the following conditions C1 to C4 are satisfied.

Condition C1: In each of the sightseeing spots SP1 to SP3, there is a time slot (spot time slot) in which the corresponding degree of congestion, CON_SP1 to CON SP3, is less than the threshold value (spot threshold value).
Condition C2: When condition C1 is satisfied, the spot time slots in which the degree of congestion is less than the spot threshold value do not overlap each other in the sightseeing spots SP1 to SP3.
Condition C3: There is a time slot (area time slot) in which the degree of congestion CON_AR_TUR is less than the threshold value (area threshold value).
Condition C4: When conditions C2 and C3 are satisfied, all of the spot time slots that do not overlap each other in the sightseeing spots SP1 to SP3 are included in an area time slot in which the degree of congestion is less than the area threshold value.

When it is determined that all the conditions are met for setting the visit time frames TZ_SP1, TZ_SP2, and TZ_SP3, these visit time frames are set based on the spot time slots of the sightseeing spots SP1 to SP3 when the condition C4 is satisfied, the stay times ST1 to ST3, and the tour time frame TZ_TUR. When the preset spot time slot is longer than the stay times ST1 to ST3, these visit time frames are set each within the preset spot time slot. On the other hand, when the preset spot time slot is shorter than the stay times ST1 to ST3, these visit time frames are set each by combining two or more spot time slots.

When the visit time frames TZ_SP1, TZ_SP2, and TZ_SP3 are set, the order of visiting these sightseeing spots (visit order) can be identified. In addition, when the visit time frames TZ_SP1, TZ_SP2, and TZ_SP3 are set, the information on the time frame (for example, visit time frames TZ_SP1 and TZ_SP2) for visiting each of the two sightseeing spots (for example, sightseeing spots SP1 and SP2) arranged in the visit order can be used to calculate the time interval that can be allocated to travel between these sightseeing spots.

When the order of visiting the sightseeing spots SP1 to SP3 is identified, the time required to travel among the sightseeing spots SP1 to SP3 by the vehicle VH1 can be calculated. FIG. 3 is a diagram showing a list of the routes RTs among the sightseeing spots SP1 to SP3. For example, consider a case in which the sightseeing spots are visited in the visit order of SP1, SP2, and SP3. In this case, the time required to travel on the routes RT12 and RT23 by the vehicle VH1 is calculated. The time required to travel on the routes RT12 and RT23 is calculated, for example, assuming that the vehicle VH1 travels on these routes at legal speeds.

In the embodiment, the time interval that can be allocated to travel between two sightseeing spots arranged in the visit order is compared with the time required to travel between these sightseeing spots by the vehicle VH1. The result of this comparison indicating that the former is longer than the latter means that the two sightseeing spots can be visited according to the visit order. Conversely, the result of this comparison indicating that the former is shorter than the latter means that the two sightseeing spots cannot be visited according to the visit order.

When the above-described comparison confirms that the sightseeing spots SP1-SP3 can be visited according to the visit order, a candidate C_PLN is generated. This candidate C_PLN includes the information on the visit time frames TZ_SP1, TZ_SP2, and TZ_SP3.

### 1-2-2. Generation of Candidate for Alternative Tour Plan

When not all the conditions are met for setting visit time frames TZ_SP1, TZ_SP2 and TZ_SP3 (that is, conditions C1 to C4), these visit time frames cannot be set. Therefore, in this case, a candidate C_PLN cannot be generated. In addition, even when these visit time frames are set, it may be found, as a result of the comparison of the traveling time described above, that the sightseeing spots SP1 to SP3 cannot be visited according to the visit order. In this case, too, a candidate C_PLN cannot be generated.

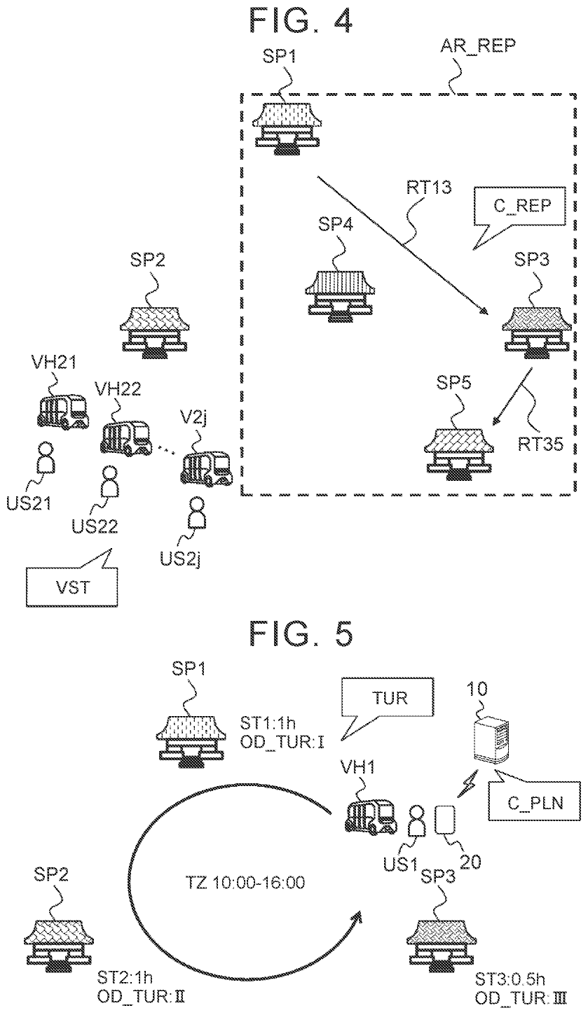

To address this problem, when a candidate C_PLN cannot be generated, the embodiment generates a candidate C_REP for an alternative tour plan REP. FIG. 4 is a diagram showing the outline of a method for generating a candidate C_REP. To generate a candidate C_REP, a part of the sightseeing spots SP1 to SP3, used to generate the candidate C_PLN, is replaced with another sightseeing spot located outside the tour area AR_TUR. In the example shown in FIG. 4, the sightseeing spot SP2 is replaced with the sightseeing spot SP5.

In order to simply replace a part of the sightseeing spots SP1 to SP3 with another sightseeing spot, one possible way is to replace the sightseeing spot SP2 with the sightseeing spot SP4 (that is, another sightseeing spot located inside the tour area AR_TUR). However, when there is no time slot in which the degree of congestion CON_AR_TUR is less than the threshold value (area threshold value) (see condition C3), the spot time slots may not be set even if the sightseeing spots SP2 is replaced with a sightseeing spot located inside the tour area AR_TUR. This is because the fact that there is no time slot in which the degree of congestion CON_AR_TUR is less than the threshold value means that the inside of the tour area AR_TUR continues to be congested.

Therefore, in the embodiment, when generating a candidate C_REP, a part of the sightseeing spots SP1 to SP3 is replaced with another sightseeing spot located outside the tour area AR_TUR. When a sightseeing spot is replaced, the tour area AR_TUR is changed. The tour area AR_REP shown in FIG. 4 is set so that all of the sightseeing spots SP1, SP3 and SP5 are located inside the tour area AR_REP.

The generation method for the candidate C_REP after the tour area AR_REP is set is basically the same as that for the candidate C_REP described with reference to FIG. 2 and FIG. 3. The generation of the candidate C_REP is repeated while continuing to change the tour area AR_REP until the candidate C_REP is generated. As described above, sightseeing spots include not only spots directly related to sightseeing but also spots indirectly related to sightseeing. Therefore, when the sightseeing spot before the change is a spot directly related to sightseeing, it is desirable that the sightseeing spot after the change be of the same type. Similarly, when the sightseeing spot before the change is a spot indirectly related to sightseeing, it is desirable that the sightseeing spot after the change be also a spot of the same type.

It is desirable that the sightseeing spot after the change be less well-known than that before the change. A less well-known sightseeing spot increases the probability of generating a candidate C_REP. In addition to this, using a less well-known sightseeing spot can revitalize the less well-known sightseeing spot and, eventually, revitalizes the entire sightseeing area including this sightseeing spot.

As described above, when proposing a plan to tour at least three sightseeing spots in a sightseeing area, the embodiment makes it possible to generate a candidate C_PLN considering not only the degree of congestion in each of the sightseeing spots but also the degree of congestion in the tour area in which the sightseeing spots are included. In addition, when a candidate C_PLN cannot be generated, the embodiment makes it possible to generate a candidate C_REP by replacing a part of the sightseeing spots with another sightseeing spot located outside the tour area before the change. Therefore, it is possible to propose a candidate C_PLN or a candidate C_REP to the user US1.

### 1-3. Another Generation Example of Candidate for Tour Plan (Hereinafter Also Referred to as “Second Generation Example”)

In the description below, the example described with reference to FIG. 1 to FIG. 4 will also be referred to as a “first generation example.” In the first generation example, it is assumed that the tour schedule information TUR, used to generate a candidate C_PLN (or candidate C_REP), includes the information on the sightseeing spots SP1 to SP3, the information on the stay times ST1 to ST3 at these sightseeing spots, and the information on the day and on the time frame in which the user will tour these sightseeing spots. The following describes a method for generating a candidate C_PLN when the information on the order of visiting these sightseeing spots (visit order) is added to the information described above.

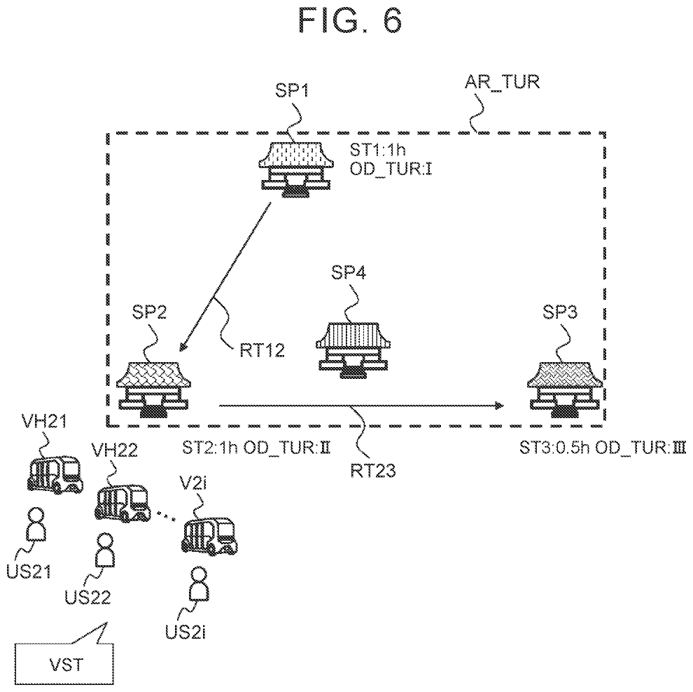

FIG. 5 and FIG. 6 are diagrams showing the outline of another method for generating a candidate C_PLN. The outline shown in FIG. 5 is basically the same as that shown in FIG. 1. However, in the example shown in FIG. 5, the information on the visit order OD_TUR for visiting the sightseeing spots SP1 to SP3 is added to the tour schedule information TUR. The visit order OD_TUR is set in the order of sightseeing spots SP1, SP2, and SP3. The visit order OD_TUR is set by the user US1. The information on the visit order OD_TUR is sent from the user terminal 20 to the server 10 together with the other tour schedule information TUR (for example, information on sightseeing spots SP1 to SP3).

In the second generation example, the tour area AR_TUR is set first as shown in FIG. 6. When the tour area AR_TUR is set, a sightseeing spot other than the sightseeing spots SP1 to SP3 and located inside the tour area AR_TUR is identified. In addition, when the sightseeing spots located inside the tour area AR_TUR (that is, the sightseeing spots SP1 to SP4) are identified, the degrees of congestion CON_SP1 to CON_SP4 of these sightseeing spots and the degree of congestion CON_AR_TUR of the tour area AR_TUR are predicted. Up to this point, the processing is the same as in the first example.

After the degrees of congestion CON_SP1 to CON_SP4 and the degree of congestion CON_AR_TUR are predicted, it is determined, based on these degrees of congestion, whether all the conditions are met for setting the time frames for visiting the sightseeing spots SP1 to SP3 (that is, visit time frames TZ_SP1, TZ_SP2, and TZ_SP3) according to the visit order OD_TUR. This determination is made, for example, based on whether all of the following conditions C5 to C9 are satisfied.

Condition C5: In each of the sightseeing spots SP1 to SP3, there is a time slot (spot time slot) in which the corresponding degree of congestion, CON_SP1 to CON SP3, is less than the threshold value (spot threshold value).
Condition C6: When condition C5 is satisfied, the spot time slots in which the degree of congestion is less than the spot threshold value do not overlap each other in the sightseeing spots SP1 to SP3.
Condition C7: When condition C6 is satisfied, the spot time slots in which the degree of congestion is less than the spot threshold value can be arranged according to the visit order OD_TUR.
Condition C8: There is a time slot (area time slot) in which the degree of congestion CON_AR_TUR is less than the threshold value (area threshold value).
Condition C9: When conditions C7 and C8 are satisfied, all of the spot time slots that are arranged in the visit order OD_TUR are included in an area time slot in which the degree of congestion is less than the area threshold value.

Note that, substantially, condition C5 is the same as condition C1, condition C8 is the same as condition C3, and condition C6 is the same as condition C2.

When it is determined that all the conditions are met for setting the time frames for visiting the sightseeing spots SP1 to SP3 according to the visit order OD_TUR, these visit time frames are set based on the spot time slots of the sightseeing spots SP1 to SP3 when the condition C9 is satisfied, the stay times ST1 to ST3, and the tour time frame TZ_TUR. Note that the length of the visit time frame is adjusted according to the relationship between the stay times ST1 to ST3 and the preset length of the spot time slot as in the first generation example.

When the time frames are set for visiting the sightseeing spots SP1-SP3 according to the visit order OD_TUR, the time required to travel among the sightseeing spots SP1 to SP3 according to the visit order OD_TUR is calculated. Unlike the first generation example, the information on the visit order OD_TUR is set by the user US1 in the second generation example. Therefore, when the time frames for visiting sightseeing spots SP1 to SP3 are set according to visit order OD_TUR, the information on the time frame (for example, visit time frames TZ_SP1 and TZ_SP2) for visiting each of the two sightseeing spots (for example, sightseeing spots SP1 and SP2), arranged in the visit order OD_TUR, can be used to calculate the time interval that can be allocated to travel between these sightseeing spots.

As in the first generation example, the time required to travel among the sightseeing spots SP1 to SP3 by the vehicle VH1 is calculated in the second generation example. In addition, the time interval that can be allocated to travel between two sightseeing spots arranged in the visit order is compared with the time required to travel between these sightseeing spots by the vehicle VH1. The result of this comparison indicating that the former is longer than the latter means that the two sightseeing spots can be visited according to the visit order OD_TUR. Conversely, the result of this comparison indicating that the former is shorter than the latter means that the two sightseeing spots cannot be visited according to the visit order OD_TUR.

When the above-described comparison confirms that the sightseeing spots SP1-SP3 can be visited according to the visit order OD_TUR, a candidate C_PLN is generated. This candidate C_PLN includes the information on the time frames for visiting sightseeing spots SP1 to SP3 according to visit order OD_TUR.

### 1-4. Another Generation Example of Candidate for Alternative Tour Plan

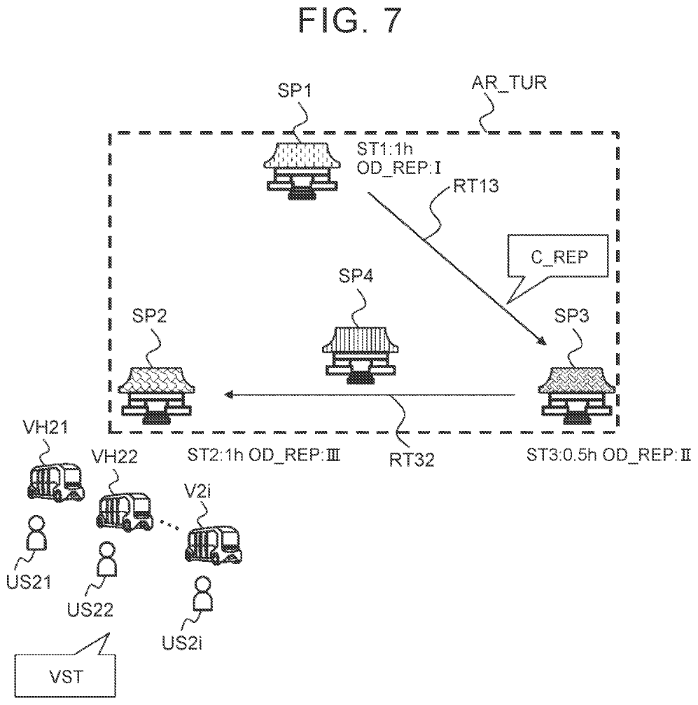

A situation in which a candidate C_PLN cannot be generated as described in the first generation example may also occur in the second generation example. Therefore, when a candidate C_PLN cannot be generated, a candidate C_REP for an alternative tour plan REP is generated in the second generation example as in the first generation example. FIG. 7 is a diagram showing the outline of another method for generating a candidate C_REP. In the example shown in FIG. 7, the information on the visit order OD_TUR is changed. The visit order OD_REP after the change is the order of SP1, SP3, and SP2.

Unlike in the first generation example, it is determined in the second generation example whether all the conditions are met for setting the visit time frames TZ_SP1, TZ_SP2, and TZ_SP3, based on the information included in the tour schedule information TUR to which the information on the visit order OD_TUR is added. That is, the tour schedule information TUR includes more information in the second generation example than in the first generation example, and this may prevent the above conditions from being met. Considering this, changing the visit order OD_TUR is expected to increase the possibility that all of the above conditions are met.

The method for generating a candidate C_REP based on the tour schedule information TUR that includes the visit order OD_REP is basically the same as that for generating a candidate C_REP described with reference to FIG. 5 and FIG. 6. The generation of a candidate C_REP is repeated while changing the visit order OD_REP until the candidate C_REP is generated.

As described above, the same effect can be achieved in the second generation example as in the first generation example even when the information on the visit order OD_TUR is added to the tour schedule information TUR.

The embodiment will be described below in detail.

### 2. Tour Plan Proposal Device

### 2-1. Configuration Example

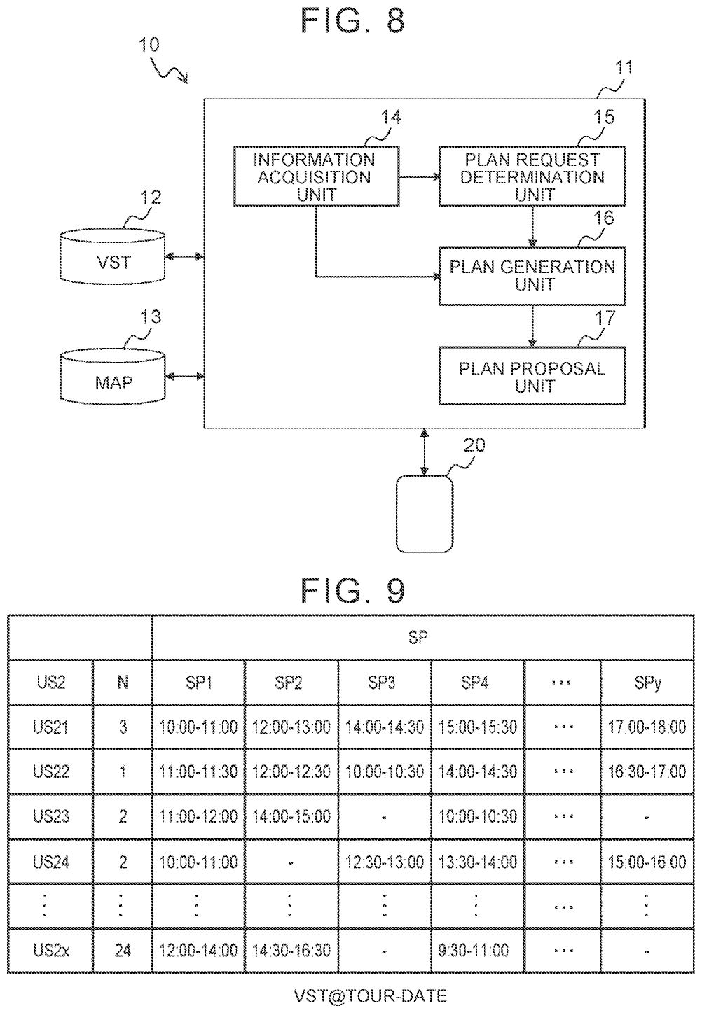

FIG. 8 is a diagram showing a configuration example of the server 10 that is the proposal device in the embodiment. The configuration example shown in FIG. 8 includes an information processing device 11, a visit plan database (DB) 12, and a map DB 13.

The information processing device 11 is a computer that processes various types of information related to the management of a tour plans PLN, such as the generation of a candidate C_PLN and a candidate C_REP and the proposal of these candidates to the user US1. When vehicle VHi (or vehicle VHj) is a rental car, the information processing device 11 is also a computer that processes various types of information related to the management of these vehicles. The information processing device 11 typically includes at least one processor and at least one memory. The processor includes a central processing unit (CPU). The memory is a volatile memory, such as a DDR memory, into which various programs, used by the processor, are read and in which various types of information are temporarily stored.

FIG. 8 shows the functional blocks of the information processing device 11 related to the management of a tour plan PLN. In the example shown in FIG. 8, the information processing device 11 includes an information acquisition unit 14, a plan request determination unit 15, a plan generation unit 16, and a plan proposal unit 17. The functions of these blocks are implemented when the processor of the information processing device 11 executes various programs stored in the memory of the information processing device 11.

The information acquisition unit 14 acquires various types of information sent from a user terminal (for example, the user terminal 20 of the user US1) of the sightseeing service. The various types of information sent from the user terminal 20 include the information, such as the user ID information, that is required for the management of the sightseeing service. The various types of information also include the information, such as the tour schedule information TUR and the information on permission or non-permission for a candidate C_REP, that is required for the generation of a tour plan PLN (or alternative tour plan REP), for the proposal of a candidate for the tour plan, and for the registration of the tour plan PLN (or alternative tour plan REP).

When the tour schedule information TUR is received, the information acquisition unit 14 sends the received tour schedule information TUR to the plan request determination unit 15. When the permission information on a candidate C_REP is received, the information acquisition unit 14 sends this permission information to the plan proposal unit 17. When the non-permission information on a candidate C_REP is received, the information acquisition unit 14 sends this non-permission information to the plan request determination unit 15.

When the tour schedule information TUR is received, the information acquisition unit 14 also accesses the visit plan DB 12 and the map DB 13 and, by referring to the information included in the tour schedule information TUR, extracts specific information from these databases. More specifically, the information acquisition unit 14 refers to the information on the tour date included in the tour schedule information TUR and extracts the visit schedule information VST corresponding to this tour date from the visit plan DB 12. The information acquisition unit 14 also refers to the information on the sightseeing spot, included in the tour schedule information TUR, and extracts the map information MAP around this sightseeing spot from the map DB 13. The information acquisition unit 14 sends the extracted information to the plan generation unit 16.

The plan request determination unit 15 determines whether the generation of a tour plan PLN is required, based on the information included in the tour schedule information TUR received from the information acquisition unit 14. For example, when the total number of sightseeing spots included in the tour schedule information TUR is three or more and when these sightseeing spots are to be visited on the same day, it is determined that the generation of a tour plan PLN is required. When it is determined that the generation of a tour plan PLN is required, the plan request determination unit 15 sends the generation command to the plan generation unit 16.

The plan request determination unit 15 also determines whether the generation of an alternative tour plan REP is required, based on the non-permission information for a candidate C_REP received from the information acquisition unit 14. When the non-permission information is received, it is determined, in principle, that the generation of an alternative tour plan REP is required. When it is determined that generation of an alternative tour plan REP is required, the plan request determination unit 15 sends the generation command to the plan generation unit 16.

When the generation command is received from the plan request determination unit 15, the plan generation unit 16 uses the information received from the information acquisition unit 14 to generate a candidate C_PLN for the tour plan PLN or a candidate C_REP for the alternative tour plan REP. The plan generation unit 16 sends the generated candidate C_PLN or C_REP to the plan proposal unit 17.

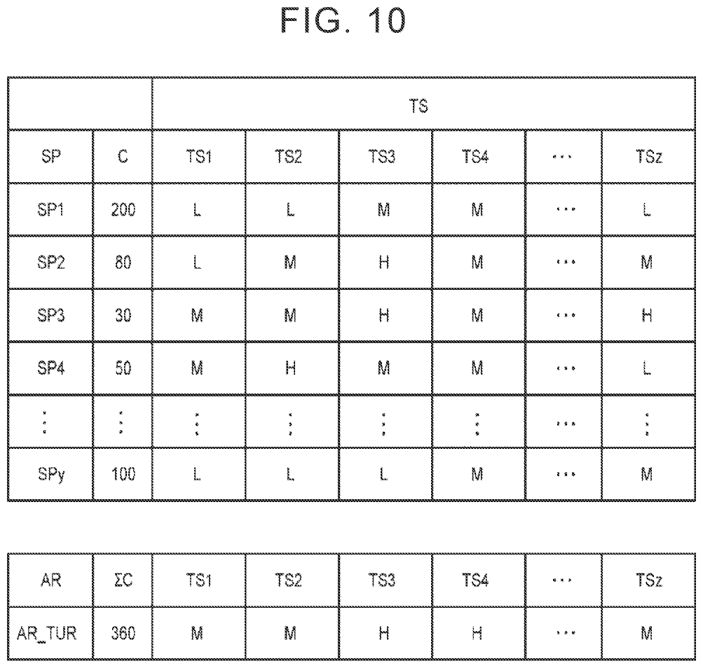

An example of the generation of a candidate C_PLN will be described below with reference to FIG. 9 and FIG. 10. FIG. 9 shows an example of the visit schedule information VST registered in the visit plan DB 12. FIG. 9 shows a list of the visit schedule information VST on the users US2x (x≥i) scheduled on the same day as the tour date. In the example shown in FIG. 9, the visit schedule information VST includes the information on the number of people N of a group, the information on the sightseeing spots SPy (y≥4), and the information on the time frames for visiting these sightseeing spots. In other words, the information shown in FIG. 9 is a list of the visit schedule information VST on the tour date extracted from the visit plan DB 12.

The plan generation unit 16 sets the tour area AR_TUR based on the information on the sightseeing spots included in the tour schedule information TUR. Then, from the visit schedule information VST, the plan generation unit 16 extracts the information corresponding to the sightseeing spots located inside the tour area AR_TUR. In the examples described with reference to FIG. 1 to FIG. 4, the information extracted as sightseeing spots located inside the tour area AR_TUR is the information on the sightseeing spots SP1 to SP4.

When the information is extracted from the visit schedule information VST, the degree of congestion in each of the extracted sightseeing spots is predicted. FIG. 10 shows an example of the degrees of congestion in the sightseeing spots. In the example shown in FIG. 10, three levels of degree of congestion (L, M, H) of sightseeing spots are calculated for each of the time slots TS. The degree of congestion is a percentage calculated based on the capacity C of a sightseeing spot and the total number of people visiting this sightseeing spot, expressed in three levels: low (e.g., lower than 30%), medium (e.g., 30% to 60%), and high (higher than 60%).

When the information is extracted from the visit schedule information VST, the degree of the congestion in the tour area AR_TUR that includes the extracted sightseeing spots is also predicted. This congestion level is a percentage calculated based on the total number of people EC in the tour area AR_TUR and the total number of people visiting this tour area AR_TUR, expressed in three levels: low, medium, and high. Like the degree of congestion in a sightseeing spot, the degree of congestion in the tour area AR_TUR is calculated for each of the time slots TS. When a tour area AR_REP is set, the degree of congestion in the tour area AR_REP is calculated by the same method used to calculate the degree of congestion in the tour area AR_TUR.

When the degrees of congestion CON_SP1 to CON_SP4 and the degree of congestion CON_AR_TUR are predicted, the plan generation unit 16 determines, based on these degrees of congestion, whether all the conditions are met for setting the time frame to visit each of the sightseeing spots included in the tour schedule information TUR. For example, the plan generation unit 16 makes this determination based on the combination of conditions C1 to C4 or the combination of conditions C5 to C9 described above. In the example described with reference to FIG. 1 to FIG. 4, the sightseeing spots included in the tour schedule information TUR are sightseeing spots SP1 to SP3. Therefore, the plan generation unit 16 determines whether all the conditions are met for setting the visit time frames TZ_SP1, TZ_SP2, and TZ_SP3.

When it is determined that all the conditions are met for setting the time frames to visit each of the sightseeing spots included in the tour schedule information TUR, the plan generation unit 16 calculates the time interval that can be allocated to travel between these sightseeing spots, based on the information on the time frame to visit each of the two sightseeing spots arranged in the visit order. In addition, the plan generation unit 16 calculates the time required to travel by vehicle between these sightseeing spots. After that, the plan generation unit 16 compares these two to determine whether the sightseeing spots included in the tour schedule information TUR can be visited according to the visit order.

The plan generation unit 16 performs the above processing to generate a candidate C_PLN. If a candidate C_PLN cannot be generated, the plan generation unit 16 changes a part of the sightseeing spots, included in the tour schedule information TUR, to another sightseeing spot located outside the tour area AR_TUR. Then, the plan generation unit 16 generates a candidate C_PLN (first generation example). When the tour schedule information TUR includes the information on the visit order OD_TUR, the plan generation unit 16 changes the visit order OD_TUR to generate a candidate C_PLN (second generation example).

The plan proposal unit 17 sends the candidate C_PLN or C_REP, received from the plan generation unit 16, to the user terminal from which the tour schedule information TUR was received. After sending the candidate C_PLN, the plan proposal unit 17 registers the information on the visit time frames for visiting the sightseeing spots, included in the candidate C_PLN, in the visit plan DB 12. After sending the candidate C_REP, the plan proposal unit 17 receives the permission information for this candidate C_REP from the information acquisition unit 14 and, then, registers the information on the visit time frames for visiting the sightseeing spots, included in the candidate C_REP, in the visit plan DB 12.

### 2-2. Example of Information Processing

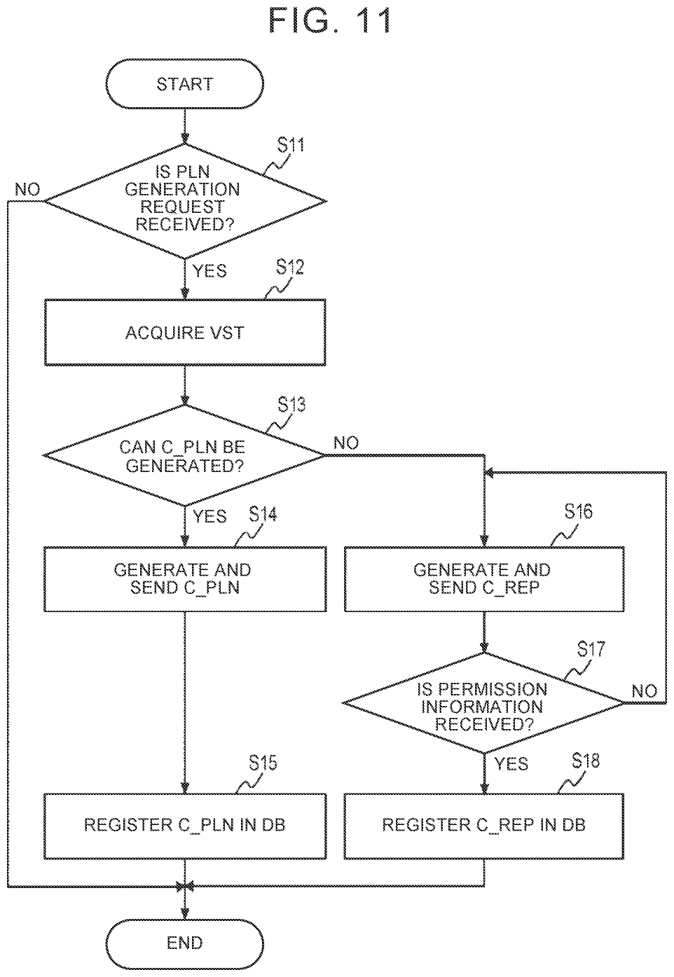

FIG. 11 is a flowchart showing the flow of processing that is performed by the information processing device 11 (processor) particularly for the processing related to the embodiment. The routine shown in FIG. 11 is repeatedly executed, for example, at predetermined intervals.

In the routine shown in FIG. 11, it is determined first whether a request to generate a tour plan PLN is received (step S11). For example, when the total number of sightseeing spots included in the tour schedule information TUR is three or more and these sightseeing spots are to be visited on the same date, it is determined that the generation of the tour plan PLN is required. When the determination result in step S11 is negative, the routine ends.

When the determination result in step S11 is affirmative, the visit schedule information VST is extracted (step S12). The extracted visit schedule information VST is the information corresponding to the tour date included in the tour schedule information TUR.

Following the processing in step S12, it is determined whether a candidate C_PLN can be generated (step S13). More specifically, in the processing in step S13, the tour area AR_TUR is set and, based on the information on this tour area AR_TUR and on the visit schedule information VST extracted in the processing in step S12, the information corresponding to the sightseeing spots located inside the tour area AR_TUR are extracted. Then, the degree of congestion in each of the extracted sightseeing spots and the degree of congestion in the tour area AR_TUR are calculated.

In the processing in step S13, based on the degree of congestion in each of the extracted sightseeing spots and the degree of congestion in the tour area AR_TUR, it is determined whether all the conditions are met for setting the time frame for visiting each of the sightseeing spots included in the tour schedule information TUR. When the determination result is affirmative, the time interval that can be allocated to travel between the sightseeing spots is calculated based on the information on the time frame to visit each of these two sightseeing spots arranged in the visit order. In addition, the time required to travel by vehicle between these sightseeing spots is calculated.

In addition, in the processing in step S13, the time interval that can be allocated to travel between two sightseeing spots is compared with the time required to travel between these sightseeing spots. Then, when the former is longer than the latter, it is determined that the candidate C_PLN can be generated. On the other hand, when the former is shorter than the latter, it is determined that the candidate C_PLN cannot be generated. In addition, when it is determined that not all the conditions are met for setting the time frame for visiting each of the sightseeing spots included in the tour schedule information TUR, it is also determined that the candidate C_PLN cannot be generated.

When the determination result in step S13 is affirmative, a candidate C_PLN is generated and sent (step S14). The sending destination of the candidate C_PLN is the user terminal from which the tour schedule information TUR was sent. Following the processing in step S14, the information included in the candidate C_PLN is registered in the visit plan DB 12 (step S15). The information included in the candidate C_PLN includes the information on at least three sightseeing spots and the information on the time frames for visiting each of these sightseeing spots.

When the determination result in step S13 is negative, a candidate C_REP is generated and sent (step S16). The sending destination of the candidate C_REP is the same as the sending destination of the candidate C_PLN. Following the processing in step S16, it is determined whether the permission information for the candidate C_REP is received (step S17). When the determination result in step S17 is negative, the processing in step S16 is performed again.

When the determination result in step S17 is affirmative, the information included in the candidate C_REP is registered in the visit plan DB 12 (step S18). The information included in the candidate C_REP includes the information on at least three sightseeing spots and the information on time frame for visiting each of these sightseeing spots.

### 3. Effects

According to the embodiment described above, when a plan to tour at least three sightseeing spots in a sightseeing area is proposed, a candidate C_PLN can be generated considering not only the degree of congestion in each of the sightseeing spots but also the degree of congestion in the tour area that includes these sightseeing spots. In addition, according to the embodiment, when a candidate C_PLN cannot be generated, a candidate C_REP can be generated by changing a part of the sightseeing spots to another sightseeing spot located outside the tour area before the change (first generation example). Alternatively, a candidate C_REP can be generated by changing the order (OD_TUR) of visiting the sightseeing spots (second generation example). Therefore, it becomes possible to propose a candidate C_PLN or a candidate C_REP to a user who desires a tour plan PLN.

What is claimed is:

1. A tour plan proposal method for proposing a sightseeing spot tour plan to a user, the tour plan proposal method comprising:
a step for acquiring tour schedule information of the user, the tour schedule information including information on locations of at least three sightseeing spots, information on stay times at the at least three sightseeing spots, and information on a tour time frame to tour the at least three sightseeing spots;
a step for setting a tour area including the at least three sightseeing spots based on the information on the locations;
a step for predicting degrees of congestion in the at least three sightseeing spots and a degree of congestion in the tour area;
a step for determining whether a candidate for a tour plan to tour the at least three sightseeing spots by traveling using a vehicle is able to be generated based on the information on the stay times, the information on the tour time frame, the degrees of congestion in the at least three sightseeing spots, and the degree of congestion in the tour area; and
a step for generating a candidate for an alternative tour plan when it is determined that the candidate for the tour plan is not able to be generated, the alternative tour plan being a plan in which a part of the at least three sightseeing spots is changed to a different sightseeing spot located outside the tour area.

2. The tour plan proposal method according to claim 1, wherein:
the step for predicting degrees of congestion includes
a step for acquiring visit schedule information of another user who is to visit at least one sightseeing spot located inside the tour area on a day to which the tour time frame belongs, the visit schedule information of another user including information on a location of the at least one sightseeing spot and information on a visit time frame to visit the at least one sightseeing spot, and
a step for calculating a degree of congestion in the at least one sightseeing spot and a degree of congestion in the tour area for each preset time slot based on the information on the visit time frame to visit the at least one sightseeing spot; and
in the step for determining whether a tour plan is able to be generated,
it is determined whether a time slot for visiting each of the at least three sightseeing spots is able to be set based on the information on the stay times, the information on the tour time frame, and the degrees of congestion in the at least one sightseeing spot and in the tour area calculated for the each time slot, and
it is determined that the tour plan is not able to be generated when it is determined that the time slot for visiting each of the at least three sightseeing spots is not able to be set.

3. The tour plan proposal method according to claim 2, wherein:
further in the step for determining whether a tour plan is able to be generated,
a time required to travel among the at least three sightseeing spots is calculated when it is determined that the time slot for visiting each of the at least three sightseeing spots is able to be set,
it is determined whether the at least three sightseeing spots are able to be toured in the tour time frame, based on the time slot for visiting each of the at least three sightseeing spots and the time required to travel among the at least three sightseeing spots, and
it is determined that the tour plan is not able to be generated when it is determined that the at least three sightseeing spots are not able to be toured in the tour time frame.

4. A tour plan proposal method for proposing a sightseeing spot tour plan to a user, the tour plan proposal method comprising:
a step for acquiring tour schedule information of the user, the tour schedule information including information on locations of at least three sightseeing spots, information on stay times at the at least three sightseeing spots, information on a tour time frame to tour the at least three sightseeing spots, and a visit order to visit the at least three sightseeing spots;
a step for setting a tour area including the at least three sightseeing spots based on the information on the locations;
a step for predicting degrees of congestion in the at least three sightseeing spots and a degree of congestion in the tour area;
a step for determining whether a candidate for a tour plan to visit the at least three sightseeing spots according to the visit order by traveling using a vehicle is able to be generated based on the information on the stay times, the information on the tour time frame, the degrees of congestion in the at least three sightseeing spots, and the degree of congestion in the tour area; and
a step for generating a candidate for an alternative tour plan when it is determined that the candidate for the tour plan is not able to be generated, the alternative tour plan being a plan in which the visit order to visit the at least three sightseeing sports is changed.

5. The tour plan proposal method according to claim 4, wherein:
the step for predicting degrees of congestion includes
a step for acquiring visit schedule information of another user who is to visit at least one sightseeing spot located inside the tour area on a day to which the tour time frame belongs, the visit schedule information of another user including information on a location of the at least one sightseeing spot and information on a visit time frame to visit the at least one sightseeing spot, and
a step for calculating a degree of congestion in the at least one sightseeing spot and a degree of congestion in the tour area for each preset time slot based on the information on the visit time frame to visit the at least one sightseeing spot; and
in the step for determining whether a tour plan is able to be generated,
it is determined whether a time slot for visiting each of the at least three sightseeing spots according to the visit order is able to be set based on the information on the stay times, the information on the tour time frame, and the degrees of congestion in the at least one sightseeing spot and in the tour area calculated for the each time slot, and
it is determined that the tour plan is not able to be generated when it is determined that the time slot for visiting each of the at least three sightseeing spots according to the visit order is not able to be set.

6. The tour plan proposal method according to claim 5, wherein:
further in the step for determining whether a tour plan is able to be generated,
a time required to travel among the at least three sightseeing spots is calculated when it is determined that the time slot for visiting each of the at least three sightseeing spots according to the visit order is able to be set,
it is determined whether the at least three sightseeing spots are able to be visited according to the visit order in the tour time frame, based on the time slot for visiting each of the at least three sightseeing spots according to the visit order and the time required to travel among the at least three sightseeing spots, and
it is determined that the tour plan is not able to be generated when it is determined that the at least three sightseeing spots are not able to be visited according to the visit order in the tour time frame.

7. A tour plan proposal device for proposing a sightseeing spot tour plan to a user, the tour plan proposal device comprising a processor configured to perform:
processing for acquiring tour schedule information of the user, the tour schedule information including information on locations of at least three sightseeing spots, information on stay times at the at least three sightseeing spots, and information on a tour time frame to tour the at least three sightseeing spots;
processing for setting a tour area including the at least three sightseeing spots based on the information on the locations;
processing for predicting degrees of congestion in the at least three sightseeing spots and a degree of congestion in the tour area;
processing for determining whether a candidate for a tour plan to tour the at least three sightseeing spots by traveling using a vehicle is able to be generated based on the information on the stay times, the information on the tour time frame, the degrees of congestion in the at least three sightseeing spots, and the degree of congestion in the tour area; and
processing for generating a candidate for an alternative tour plan when it is determined that the candidate for the tour plan is not able to be generated, the alternative tour plan being a plan in which a part of the at least three sightseeing spots is changed to a different sightseeing spot located outside the tour area.
